(19) United States
(12) Patent Application Publication
(10) Pub. No.: US 2026/0029676 A1
(43) Pub. Date: Jan. 29, 2026

(54) DIMMING MODULE AND DIMMING APPARATUS

(71) Applicants: Beijing BOE Sensor Technology Co., Ltd., Beijing (CN); BOE Technology Group Co., Ltd., Beijing (CN)

(72) Inventors: Changyin WANG, Beijing (CN); Juan CHEN, Beijing (CN); Chunlei WANG, Beijing (CN); Peng LIANG, Beijing (CN); Xiaolong WU, Beijing (CN); Deshen ZHAI, Beijing (CN); Xiaoqian JU, Beijing (CN); Zhan LI, Beijing (CN); Sikai ZHANG, Beijing (CN); Naisheng LI, Beijing (CN)

(21) Appl. No.: 18/996,321

(22) PCT Filed: Mar. 21, 2023
(86) PCT No.: PCT/CN2023/082748

§ 371 Date: Jan. 17, 2025

(51) Int. Cl. G02F 1/1339; G02F 1/1337

(52) U.S. Cl. CPC G02F 1/13394; G02F 1/1337; G02F 1/13396

(57) ABSTRACT

A dimming module is provided to include a first substrate, a second substrate, spacers, a border sealing glue and dye liquid crystals; the first substrate includes a first base, a first conductive layer and a first alignment film sequentially stacked on a side of the first base close to dye liquid crystals; the spacers are on a side of the first conductive layer close to the dye liquid crystals; the second substrate includes a second base, a second conductive layer and a second alignment film sequentially stacked on a side of the second base close to dye liquid crystals; the second substrate and the first substrate are aligned and assembled, the border sealing glue is therebetween and surrounds them to form a dimming region in which the dye liquid crystals are positioned and a spacing distance between every two adjacent spacers is from 50 μm to 1000 μm.

### TECHNICAL FIELD

The present disclosure relates to the field of display technology, and in particular to a dimming module, a method for manufacturing a dimming module and a dimming apparatus.

### BACKGROUND

A flexible dye liquid crystal dimming device has advantages such as lightness and thinness, bendability, privacy protection and the like, and can better satisfy the requirements where a skylight and side windows of a passenger car are hyperbolic and lightweight, and has a simple grey black color and therefore is more high-end, which provides the user with more intelligent and comfortable driving and riding experience.

### SUMMARY

In a first aspect, an embodiment of the present disclosure provides a dimming module, including: a first substrate, a second substrate, a plurality of spacers, a border sealing glue and dye liquid crystals; wherein the first substrate includes a first base, a first conductive layer and a first alignment film; the first conductive layer and the first alignment film are sequentially stacked on a side of the first base close to the dye liquid crystals, the plurality of spacers are on a side of the first conductive layer close to the dye liquid crystals; the second substrate includes a second base, a second conductive layer and a second alignment film; the second conductive layer and the second alignment film are sequentially stacked on a side of the second base close to the dye liquid crystals; the second substrate and the first substrate are aligned with each other and assembled together, and the border sealing glue is between the first substrate and the second substrate and surrounds to form a dimming region; the dye liquid crystals are in the dimming region; and in the dimming region, a spacing distance between any two adjacent spacers is in a range from 50 μm to 1000 μm.

In some embodiments, the first base is made of any one of polyethylene terephthalate, polycarbonate, tri-cellulose acetate and cyclic olefin polymer, and the second base is made of any one of polyethylene terephthalate, polycarbonate, tri-cellulose acetate and cyclic olefin polymer.

In some embodiments, an orthographic projection of the plurality of spacers on the first substrate overlaps with an orthographic projection of the border sealing glue on the first substrate.

In some embodiments, a minimum distance between the plurality of spacers and a first edge of the border sealing glue away from the dimming region is less than the spacing distance between any two adjacent spacers.

In some embodiments, a minimum distance between the plurality of spacers and the first edge of the border sealing glue away from the dimming region is greater than the spacing distance between any two adjacent spacers.

In some embodiments, the spacing distance between any two adjacent spacers is in a range from 50 μm to 500 μm.

In some embodiments, a radial size of a first surface of each spacer on the first conductive layer is in a range from 0 μm to 40 μm, a radial size of a second surface of each spacer is in a range from 5 μm to 30 μm, and a height of each spacer is in a range from 4 μm to 30 μm.

In some embodiments, the radial size of the first surface of each spacer is in a range from 20 μm to 30 μm, the radial size of the second surface of each spacer is in a range from 10 μm to 20 μm, and the height of each spacer is in a range from 8 μm to 15 μm.

In some embodiments, the plurality of spacers include main spacers and auxiliary spacers; a radial size of a first surface of each main spacer is greater than that of a first surface of each auxiliary spacer; and/or a radial size of a second surface of each main spacer is greater than that of a second surface of each auxiliary spacer; and/or a height of each main spacer is greater than that of each auxiliary spacer.

In some embodiments, the spacing distance between any two adjacent spacers is in a range from 0.05 mm to 1 mm, and the plurality of spacers extend along a first direction and a second direction to form a mesh, and the first direction and the second direction are parallel to the first substrate and intersect with each other.

In some embodiments, a width of the first surface of each spacer in the first conductive layer is in a range from 10 μm to 30 μm, a width of the second surface of each spacer is in a range from 5 μm to 20 μm, the height of each spacer is in a range from 4 μm to 30 μm; and the plurality of spacers have a mesh shape, including a square mesh shape, a rectangular mesh shape or a regular hexagonal mesh shape.

In some embodiments, the dimming module further includes a black matrix between the first conductive layer and the plurality of spacers, wherein an orthographic projection of the plurality of spacers on the first base is within an orthographic projection of the black matrix on the first base.

In some embodiments, the second surface of each of at least a part of the plurality of spacers is in contact with the second alignment film; the dimming module includes a curved-surface region, the second substrate further includes at least one retaining ring in the curved-surface region, the at least one retaining ring is on a side of the second conductive layer close to the dye liquid crystals and extends through the second alignment film to a direction close to the first substrate; or the at least one retaining ring is on a side of the second alignment film close to the dye liquid crystals and extends to the direction close to the first substrate; and a top portion of each spacer in the curved-surface region is embedded in the corresponding retaining ring.

In some embodiments, the dimming module further includes a first barrier layer, a second barrier layer and a side glue, wherein the first barrier layer and the second barrier layer are between the first substrate and the second substrate, or the first barrier layer is on a side of the first substrate away from the dye liquid crystals and the second barrier layer is on a side of the second substrate away from the dye liquid crystals, and the side glue is between the first barrier layer and the second barrier layer and on a side of the border sealing glue away from the dimming region.

In some embodiments, the first barrier layer is between the first base and the first conductive layer; the second barrier layer is between the second base and the second conductive layer; orthographic projections of the first conductive layer, the second conductive layer, the first alignment film and the second alignment film on the first base do not overlap with orthographic projections of the border sealing glue and the side glue on the first base, and orthographic projections of the first barrier layer and the second barrier layer on the first base overlap with the orthographic projections of the border sealing glue and the side glue on the first base, and the first barrier layer and the second barrier layer are in contact with the border sealing glue and the side glue and are connected to the border sealing glue and the side glue.

In some embodiments, the first barrier layer is on a side of the first substrate away from the second substrate; the second barrier layer is on a side of the second substrate away from the first substrate; an orthographic projection of the side glue on the first barrier layer does not overlap with the first substrate; an orthographic projection of the side glue on the second barrier layer does not overlap with the second substrate; and the side glue is in contact with the first barrier layer and the second barrier layer and is connected to the first barrier layer and the second barrier layer.

In some embodiments, the first barrier layer and the second barrier layer are made of silicon nitride or silicon oxide.

In some embodiments, a thickness of the first barrier layer is in a range from 1 μm to 2 μm; and a thickness of the second barrier layer is in a range from lpm to 2 μm.

In some embodiments, each of the first barrier layer and the second barrier layer includes a base film, a barrier film and an optical adhesive film which are sequentially stacked.

In some embodiments, a thickness of the first barrier layer is in a range from 50 μm to 200 μm; and a thickness of the second barrier layer is in a range from 50 μm to 200 μm.

In some embodiments, an elastic recovery rate of the plurality of spacers under a pressure in a range from 5 mN to 30 mN is in a range from 80% to 90%.

In some embodiments, the dimming module has a resistance to a laminating pressure more than 80 kgf/cm².

In a second aspect, an embodiment of the present disclosure further provides a dimming apparatus, which includes the above dimming module; wherein the dimming apparatus further includes a first cover plate and a second cover plate, and the dimming module is between the first cover plate and the second cover plate, the first substrate in the dimming module is attached and adhered to the first cover plate through a first adhesive layer, the second substrate in the dimming module is attached and adhered to the second cover plate through a second adhesive layer, and the first cover plate and the second cover plate are adhered to each other by sealing the border through the first adhesive layer and the second adhesive layer.

In some embodiments, the dimming apparatus further includes a first edge covering layer and a second edge covering layer, wherein the first edge covering layer is on a side of the first cover plate away from the second cover plate, and an orthographic projection of the first edge covering layer on the first cover plate covers a region from the border sealing glue in the dimming module to an edge of the first cover plate, and the second edge covering layer is on a side of the second cover plate away from the first cover plate, and an orthographic projection of the second edge covering layer on the second cover plate covers a region from the border sealing glue in the dimming module to an edge of the second cover plate.

In a third aspect, an embodiment of the present disclosure further provides a method for manufacturing a dimming module, including: forming a first substrate; forming a second substrate; and aligning and assembling the first substrate and the second substrate, sealing a border by using a border sealing glue, and filling dye liquid crystals into a dimming region enclosed by the border sealing glue; the forming the first substrate includes: forming a first conductive layer on a first base; forming a plurality of spacers on the first base after the above step is completed; and forming a first alignment film on the first base after the above steps are completed; the forming the second substrate includes: forming a second conductive layer on a second base; and forming a second alignment film on the second base after the above step is completed.

In some embodiments, the forming the plurality of spacers on the first base after the step of forming the first conductive layer by using an exposure process includes: coating a photoresist film on a side of the first conductive layer away from the first base; drying the photoresist film at a temperature in a range from 80′C to 100° C. for a duration in a range from 100 seconds to 120 seconds; exposing the photoresist film by using a mask plate with a light-transmitting pattern through ultraviolet light, so that a portion of the photoresist film in a region corresponding to the light-transmitting pattern is subjected to polymerization reaction; spraying a potassium hydroxide solution on the exposed photoresist film, and removing a portion of the photoresist film, which is not subjected to the polymerization reaction and is in a region except for the region corresponding to the light-transmitting pattern, to form a pattern of the plurality of spacers; and curing the pattern of the plurality of spacers at a temperature in a range from 100° C. to 110° C. for a duration in a range from 50 minutes to 60 minutes, to form the plurality of spacers.

### BRIEF DESCRIPTION OF DRAWINGS

The accompanying drawings, which are provided for further understanding of embodiments of the present disclosure and constitute a part of this specification, are for explaining the present disclosure together with the embodiments of the present disclosure, but are not intended to limit the present disclosure. The above and other features and advantages will become more apparent to one of ordinary skill in the art by describing in detail exemplary embodiments thereof with reference to the drawings. In the drawings:

FIG. 1 is a schematic cross-sectional view of a structure of a dye liquid crystal dimming device in the related art.

FIG. 2 is a schematic view illustrating white spots due to collapse of a cell gap.

FIG. 3 is a schematic cross-sectional view of a structure of a first substrate according to an embodiment of the present disclosure.

FIG. 4 is a test curve for elastic recovery rate of a spacer.

FIG. 5a is a schematic view illustrating a distribution of a plurality of spacers on a first base which is flexible.

FIG. 5b is a schematic view illustrating another distribution of a plurality of spacers on a first base which is flexible.

FIG. 5c is a schematic view illustrating another distribution of a plurality of spacers on a first base which is flexible.

FIG. 5d is a schematic view illustrating a distribution of a plurality of spacers on a first base which is rigid.

FIG. 6a is a schematic view illustrating a distribution of a plurality of spacers only in a dimming region.

FIG. 6b is a schematic view illustrating a distribution of a plurality of spacers in both a dimming region and a border region.

FIG. 6c is a schematic view illustrating a distribution of a plurality of spacers in both a dimming region and a part of a border region.

FIG. 7a is a schematic cross-sectional view of a spacer in a plane perpendicular to a first base according to an embodiment of the present disclosure.

FIG. 7b is a schematic cross-sectional view of a spacer in a plane perpendicular to a first base according to an embodiment of the present disclosure.

FIG. 8a is a schematic cross-sectional view of a structure of a first substrate with main spacers and auxiliary spacers according to an embodiment of the present disclosure.

FIG. 8b is a schematic view illustrating a distribution of main spacers and auxiliary spacers according to an embodiment of the present disclosure.

FIG. 9a is a schematic view illustrating a distribution of spacers in a strip shape according to an embodiment of the present disclosure.

FIG. 9b is a schematic view illustrating a distribution of spacers in a square mesh shape according to an embodiment of the present disclosure.

FIG. 9c is a schematic view illustrating a distribution of spacers in a rectangular mesh shape according to an embodiment of the present disclosure.

FIG. 9d is a schematic view illustrating a distribution of spacers in a regular hexagonal mesh shape according to an embodiment of the present disclosure.

FIG. 9e is a schematic view illustrating a distribution of spherical spacers according to an embodiment of the present disclosure.

FIG. 10 is a schematic cross-sectional view of a structure of a first substrate with spacers made of a photoresist material containing a black pigment according to an embodiment of the present disclosure.

FIG. 11 is a schematic cross-sectional view of a structure of a first substrate with a black matrix provided at a position of a spacer according to an embodiment of the present disclosure.

FIG. 12a is a schematic view illustrating a rubbing shadow region occurring in a first alignment film during a rubbing alignment process.

FIG. 12b is a schematic view illustrating a principle of light leakage caused by alignment of liquid crystal molecules around a spacer.

FIG. 12c is a schematic view illustrating light leakage occurring around spacers in a first alignment film formed through a rubbing alignment process and a photo-alignment process.

FIG. 13 is a schematic view illustrating a procedure of sequentially forming spherical spacers and a first alignment film on a first conductive layer.

FIG. 14 is a schematic cross-sectional view of a structure of a dimming module according to an embodiment of the present disclosure.

FIG. 15a is a schematic cross-sectional view of a structure of a part of a dimming module in a curved-surface region according to an embodiment of the present disclosure.

FIG. 15b is a schematic cross-sectional view of another structure of a part of a dimming module in a curved-surface region according to an embodiment of the present disclosure.

FIG. 16 is a schematic diagram illustrating that a top portion of a spacer is nested in a retaining ring according to an embodiment of the present disclosure.

FIG. 17 is a schematic cross-sectional view of a structure of a flexible dimming module having a curved-surface region in the related art.

FIG. 18 is a schematic cross-sectional view of another structure of a dimming module according to an embodiment of the present disclosure.

FIG. 19 is a schematic cross-sectional view of another structure of a dimming module according to an embodiment of the present disclosure.

FIG. 20 is a schematic cross-sectional view of a structure of a dimming apparatus according to an embodiment of the present disclosure.

### DETAIL DESCRIPTION OF EMBODIMENTS

In order to enable one of ordinary skill in the art to better understand the technical solutions of the embodiments of the present disclosure, a dimming module, a method for manufacturing a dimming module and a dimming apparatus provided by the embodiments of the present disclosure will be described in further detail with reference to the accompanying drawings and the detailed description.

The embodiments of the present disclosure will be described more fully hereinafter with reference to the accompanying drawings, but the embodiments shown may be embodied in different forms and should not be construed as limited to the embodiments set forth herein. Rather, these embodiments are provided so that this disclosure will be thorough and complete, and will fully convey the scope of the present disclosure to one ordinary skill in the art.

The embodiments of the present disclosure are not limited to the embodiments shown in the drawings, but include modifications of configurations formed based on a manufacturing process. Thus, areas illustrated in the drawings have schematic properties, and shapes of the areas shown in the drawings illustrate specific shapes of the areas of elements, but are not intended to be limiting.

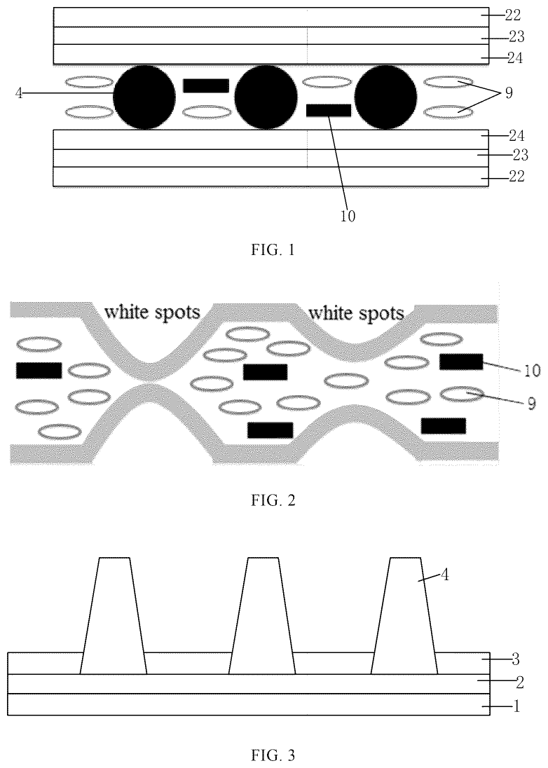

FIG. 1 is a schematic cross-sectional view of a structure of a dye liquid crystal dimming device in the related art. Referring to FIG. 1, the dye liquid crystal dimming device includes an upper substrate and a lower substrate which are aligned and assembled, to form a cell filled with dye liquid crystals, the dye liquid crystals include liquid crystal molecules 9 and dye molecules 10, each of the upper substrate and the lower substrate includes a flexible base 22, an electrode layer 23 and an alignment film 24, and the alignment film 24 is arranged on a side of the electrode layer 23 away from the flexible base 22 in each of the upper substrate and the lower substrate, and supporting spacers 4 are provided in the cell and on one of the upper substrate and the lower substrate (such as the lower substrate) and are configured to support the upper substrate and the lower substrate which are aligned and assembled.

In the related art, the supporting spacers 4 are spherical, and are formed by spraying a material of the supporting spacers 4 on the alignment film 24 of one of the upper substrate and the lower substrate, and then thermally curing the sprayed material so that the cured material is adhered to the alignment film 24 of the one of the upper substrate and the lower substrate. On one hand, the spraying process will cause the poor distribution uniformity of the supporting spacers 4, and on the other hand, each supporting spacer 4 is in point contact with the alignment film 24 due to the spherical shape of the supporting spacer 4, so that the adhering force between the cured spherical supporting spacer 4 and the alignment film 24 is small. Therefore, the spherical supporting spacer is easy to fall off under the action of external force. In a region without the supporting spacers or a region with a lower distribution density of the supporting spacers 4 inside the cell, white spots are caused by a collapse of a cell gap in the flexible dye liquid crystal dimming device (referring to FIG. 2, which is a schematic view illustrating white spots due to collapse of a cell gap). A specific principle of the white spot defect is as follows: in a normal operation of the flexible dye liquid crystal dimming device, when the upper electrode layer 23 (the electrode layer 23 of the upper substrate) and the lower electrode layer 23 (the electrode layer 23 of the lower substrate) are not powered on, the dye liquid crystals cannot allow light to transmit through the dye liquid crystals, so that the flexible dye liquid crystal dimming device is in a light-proof state. When the upper electrode layer 23 and the lower electrode layer 23 are powered on, the dye liquid crystals can allow light to transmit through the dye liquid crystals, so that the flexible dye liquid crystal dimming device is in a light-transmitting state. The white spots are caused by the fact that when the upper electrode layer 23 and the lower electrode layer 23 of the flexible dye liquid crystal dimming device are not powered on, due to the collapse of the cell gap, no dye liquid crystal exists between the upper substrate and the lower substrate at the collapse position, so that a light-shielding function cannot be realized at the collapse position. That is, the white spots are caused by the flexible dye liquid crystal dimming device being in the light-transmitting state at the collapse position.

In addition, in the related art, a structure of a rigid dye liquid crystal dimming device may also be as shown in FIG. 1. The supporting spacers 4 in the rigid dye liquid crystal dimming device are also formed by spraying a material of the supporting spacers 4 on the alignment film 24 of one of the upper substrate and the lower substrate, and then thermally curing the sprayed material so that the cured material is adhered to the alignment film 24 of the one of the upper substrate and the lower substrate. In the rigid dye liquid crystal dimming device, however, a thermal curing condition for the supporting spacers 4 includes heating at 150° C. for 50 minutes to realize the curing. In addition, in the rigid dye liquid crystal dimming device, each alignment film 24 is formed by film coating and curing processes through heating. A thermal curing condition for the alignment films 24 includes heating at 230° C. for 20 minutes to achieve the curing. However, for the flexible dye liquid crystal dimming device, a tolerable process temperature of the flexible base 22 is generally less than 150° C., so it is necessary to develop a low-temperature process for forming the supporting spacers 4 and the alignment films 24.

In order to solve the above problems in the related art, in a first aspect, an embodiment of the present disclosure provides a dimming module, including: a first substrate, a second substrate, a plurality of spacers, a border sealing glue and dye liquid crystals; the first substrate includes a first base, a first conductive layer and a first alignment film sequentially stacked on a side of the first base close to the dye liquid crystals; the spacers are on a side of the first conductive layer close to the dye liquid crystals; the second substrate includes a second base, a second conductive layer and a second alignment film sequentially stacked on a side of the second base close to the dye liquid crystals; the second substrate and the first substrate are aligned and assembled, and the border sealing glue is positioned between the first substrate and the second substrate and surrounds the first substrate and the second substrate to form a dimming region; the dye liquid crystals are positioned in the dimming region; and in the dimming region, a spacing distance between any two adjacent spacers is in a range from 50 μm to 1000 μm.

In some embodiments, FIG. 3 is a schematic cross-sectional view of a structure of a first substrate according to an embodiment of the present disclosure. Referring to FIG. 3, the dimming module includes: a first substrate including a first base 1, a first conductive layer 2, a first alignment film 3, and a plurality of spacers 4; the first conductive layer 2 and the first alignment film 3 are sequentially stacked on the first base 1; the spacers 4 are positioned on the first conductive layer 2 and extend away from the first base 1 by penetrating through the first alignment film 3; and a process temperature for preparing the spacers 4 is lower than a tolerable temperature of the first base 1.

In some embodiments, the first base 1 is made of a flexible light-transmitting material, such as any one of PET (polyethylene terephthalate), PC (polycarbonate). TCA (Tri-cellulose Acetate), and COP (cyclic olefin polymer). The first conductive layer 2 is made of indium tin oxide. The layer of indium tin oxide can be made to be ultrathin, thereby realizing the first conductive layer 2 which is flexible. The indium tin oxide material is capable of transmitting light, thereby realizing the light-transmitting characteristics of the first substrate.

In some embodiments, the first alignment film 3 has a thickness in a range from 65 nm to 100 nm.

In some embodiments, the spacers 4 are made of a flexible material, and an elastic recovery rate of the spacers 4 under a pressure in a range from 5 mN to 30 mN is in a range from 80% to 90%.

In some embodiments, the dimming module has a resistance to a laminating pressure more than 80 kgf/cm².

In a laminating pressure test for the dimming module, a force with a magnitude of 80 kgf/cm² is applied to the formed dimming module through a pressure head, the spacers 4 in the dimming module are not damaged under the pressure. The laminating pressure applied to the dimming module is less than 80 kgf/cm² when the dimming module and toughened glass are laminated in an autoclave, so that the spacers 4 may sufficiently bear the laminating pressure for the dimming module and the toughened glass.

In some embodiments, the spacers 4 are made of a photoresist material, including acrylic copolymer, multifunctional monomer, photoinitiator, 1-Ethoxy-2-(2-methoxyethoxy)ethane and 1-methoxy-2-propanol.

In some embodiments, in the photoresist material of the spacers 4, a mass ratio of the acrylic copolymer is in a range from 10% to 20%, a mass ratio of the multifunctional monomer is in a range from 6% to 12%, a mass ratio of the photoinitiator is less than or equal to 5%, a mass ratio of the 1-Ethoxy-2-(2-methoxyethoxy)ethane is in a range from 50% to 67%, and a mass ratio of the 1-methoxy-2-propanol is in a range from 13% to 17%.

In some embodiments, as shown in Table 1, Table 1 shows test data for the elastic recovery rate of the spacers 4 made of the photoresist material under a pressure in a range from 5 mN to 30 mN.

TABLE 1

| F(mN) | 30 | 20 | 10 | 7.5 | 5 |
|---|---|---|---|---|---|
| Total deformation (μm) | 2.966 | 2.971 | 1.605 | 1.182 | 0.676 |
| Recovery rate % | 0.899 | 0.812 | 0.838 | 0.812 | 0.831 |

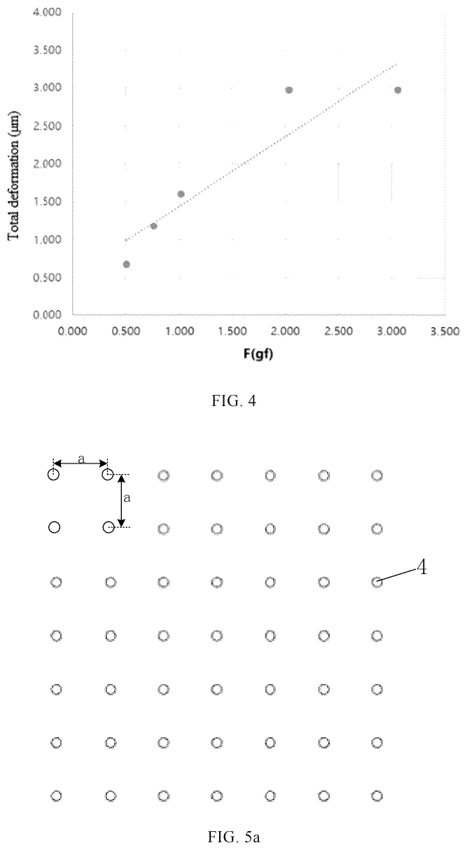

FIG. 4 is a test curve for elastic recovery rate of a spacer. Referring to FIG. 4, as can be seen from the test data in table 1, an average elastic recovery rate of the spacers 4 is 83.9%, which can well meet the requirements of the flexible supporting performance of the first substrate applied in the flexible dimming module.

In some embodiments, the plurality of spacers 4 are arranged in an array at equal intervals, and the spacing distance between any two adjacent spacers 4 is in a range from 50 μm to 500 μm. The spacing distance in such a range between any two adjacent spacers 4 can well meet requirements of the flexible supporting performance of the first substrate applied in the flexible dimming module.

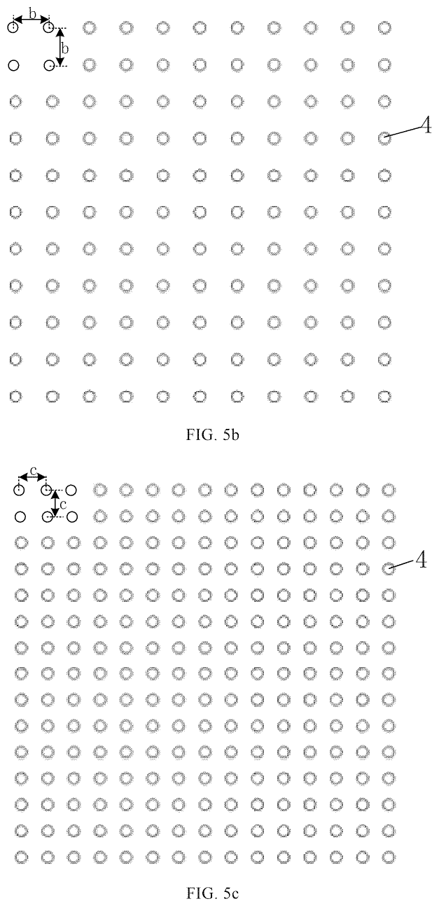

In some embodiments, FIG. 5a is a schematic view illustrating a distribution of a plurality of spacers on a first base which is flexible. Referring to FIG. 5a, the spacing distance a between any two adjacent spacers 4 is in a range from 150 μm to 180 μm. In some embodiments, the spacing distance a between any two adjacent spacers 4 is 166.67 μm, and accordingly, the distribution density of the spacers 4 is 49 ea/mm².

In some embodiments, FIG. 5b is a schematic view illustrating another distribution of a plurality of spacers on a first base which is flexible. Referring to FIG. 5b, the spacing distance b between any two adjacent spacers 4 is in a range from 80 μm to 120 μm. In some embodiments, the spacing distance b between any two adjacent spacers 4 is 100 μm, and accordingly, the distribution density of the spacers 4 is 121 ea/mm².

In some embodiments, FIG. 5c is a schematic view illustrating another distribution of a plurality of spacers on the first base which is flexible. Referring to FIG. 5c, the spacing distance c between any two adjacent spacers 4 is in a range from 50 μm to 80 μm. In some embodiments, the spacing distance c between any two adjacent spacers 4 is 71.43 μm, and accordingly, the distribution density of the spacers 4 is 225 ea/mm².

In this embodiment, the dimming module is easy to collapse without being supported by the spacers 4, but the distribution density of the spacers 4 in the above three cases can well meet the requirement of the flexible supporting performance of the first substrate applied in the flexible dimming module, the local collapse of the flexible dimming module using the first substrate caused by the low distribution density of the spacers 4 is prevented, and the problem of the white spots of the flexible dimming module is solved well.

In some embodiments, the first base 1 is made of a rigid material, such as glass. In some embodiments, the spacers 4 are made of a rigid material, such as a hard resin material or a glass material.

In some embodiments, the spacing distance between any two adjacent spacers 4 is in a range from 50 μm to 1500 μm.

In some embodiments, FIG. 5d is a schematic view illustrating a distribution of a plurality of spacers on a first base which is rigid. Referring to FIG. 5d, the spacing distance d between any two adjacent spacers 4 is 1000 μm.

In this embodiment, the first base 1 made of a rigid material has a certain rigidity, and the dimming module with better rigidity is not easy to collapse without being supported by the spacers 4, so that the spacing distance between any two adjacent spacers 4 can well meet the requirement of the rigid supporting performance of the first substrate applied in the rigid dimming module.

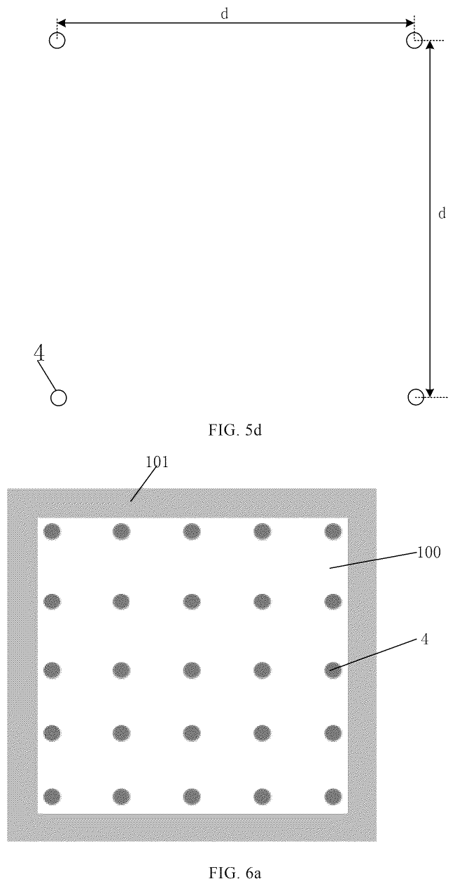

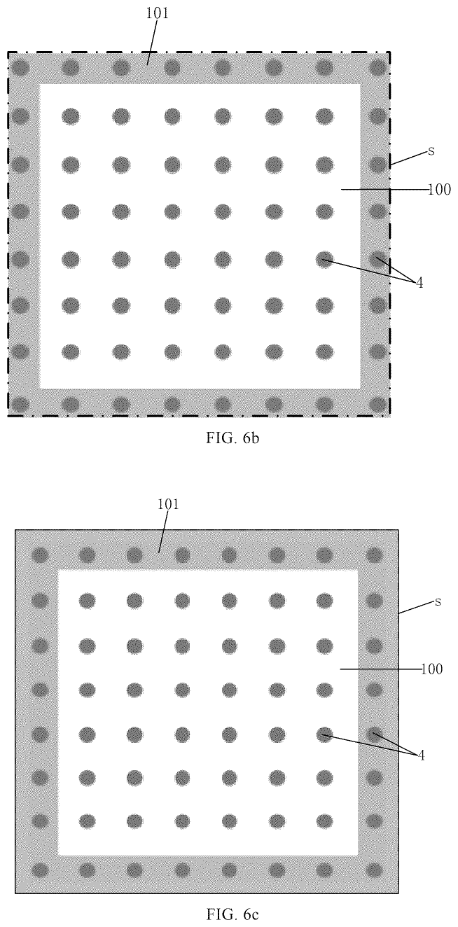

In some embodiments. FIG. 6a is a schematic view illustrating a distribution of a plurality of spacers only in a dimming region. FIG. 6b is a schematic view illustrating a distribution of a plurality of spacers in both a dimming region and a border region. Referring to FIGS. 6a and 6b, the dimming module includes a dimming region 100 and a border region 101, wherein the border region 101 is arranged around the dimming region 100; the spacers 4 are distributed in the dimming region 100, and at least in a part of the border region 101.

In some embodiments, referring to FIG. 6b, an orthographic projection of the spacers 4 on the first substrate overlaps with an orthographic projection of the border sealing glue on the first substrate.

In some embodiments, referring to FIG. 6b, a minimum distance between the plurality of spacers 4 and a first edge s of the border sealing glue away from the dimming region 100 is less than the spacing distance between any two adjacent spacers 4. That is, the spacers 4 are fully distributed in the whole region where the border sealing glue is located.

In some embodiments, FIG. 6c is a schematic view illustrating a distribution of a plurality of spacers in both a dimming region and a part of a border region. Referring to FIG. 6c, the plurality of spacers 4 are distributed in the dimming region 100, and in the part of the border region 101 close to the dimming region 100, and no spacers are distributed in a part of the border region 101 away from the dimming region 100.

In some embodiments, referring to FIG. 6c, a minimum distance between the plurality of spacers 4 and the first edge s of the border sealing glue away from the dimming region 100 is greater than the spacing distance between any two adjacent spacers 4. That is, the spacers 4 are not fully distributed in the whole region where the border sealing glue is located, and the spacers 4 are only distributed in the partial region of the region, where the border sealing glue is distributed, close to the dimming region 100.

When the first substrate is applied to the flexible dimming module, the border region 101 of the flexible dimming module is coated with the border sealing glue, so as to realize the border sealing by aligning and assembling the first substrate and the second substrate. The border region 101 is a region coated with the border sealing glue, and the region enclosed by the border sealing glue is the dimming region 100, which does not include the border region. The spacers 4 are arranged in the border region 101, and may support the border sealing glue in the border region 101, so as to support the cell gap of the border region 101.

In some embodiments, a radial size of a first surface of each spacer 4 in the first conductive layer 2 is in a range from 10 μm to 40 μm, a radial size of a second surface of each spacer 4 is in a range from 5 μm to 30 μm, and a height of each spacer 4 is in a range from 4 μm to 30 μm.

The first surface and the second surface of each spacer 4 may have any shape, and the radial size of the first surface or the second surface refers to a size between two points where a straight line passing through a center of the surface intersects with an edge of the surface.

In some embodiments, each spacer 4 has a columnar shape, including a cylindrical shape, a prismatic shape, a frustum shape or a frustum of a pyramid shape.

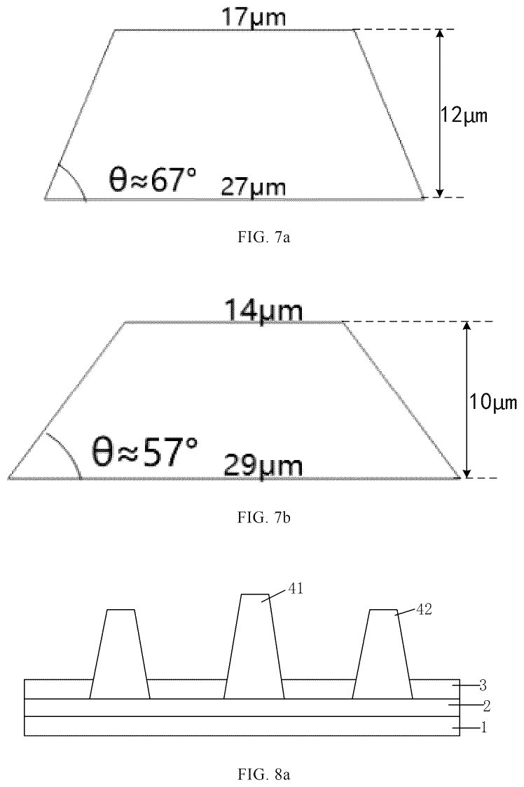

In some embodiments, FIG. 7a is a schematic cross-sectional view of a spacer in a plane perpendicular to a first base according to an embodiment of the present disclosure. Referring to FIG. 7a, each spacer 4 has a cone frustum shape, the radial size of the first surface of each spacer 4 in the first conductive layer 2 is in a range from 10 μm to 40 μm, the radial size of the second surface of each spacer 4 is in a range from 5 μm to 30 μm, and the height of each spacer 4 is in a range from 4 μm to 30 μm.

In some embodiments, a diameter of the first surface of each spacer 4 is in a range from 20 μm to 30 μm, a diameter of the second surface of each spacer 4 is in a range from 10 μm to 20 μm, and the height of each spacer 4 is in a range from 8 μm to 15 μm.

In some embodiments, referring to FIG. 7a, the diameter of the first surface of each spacer 4 is 27 μm, the diameter of the second surface of each spacer 4 is 17 μm, and the height of each spacer 4 is 12 μm.

In some embodiments, referring to FIG. 7a, a cross-sectional shape of each spacer 4 in a plane perpendicular to the first base 1 is an isosceles trapezoid. A base angle θ of the isosceles trapezoid is 67°.

In some embodiments, FIG. 7b is a schematic cross-sectional view of a spacer in a plane perpendicular to a first base according to an embodiment of the present disclosure. Referring to FIG. 7b, each spacer 4 has a cone frustum shape, the diameter of the first surface of each spacer 4 in the first conductive layer 2 is in a range from 10 μm to 25 μm, the diameter of the second surface of each spacer 4 is in a range from 8 μm to 20 μm, and the height of each spacer 4 is in a range from 3 μm to 5 μm.

In some embodiments, referring to FIG. 7b, the diameter of the first surface of each spacer 4 is 29 μm, the diameter of the second surface of each spacer 4 is 14 μm, and the height of each spacer 4 is 10 μm.

In some embodiments, referring to FIG. 7b, the cross-sectional shape of each spacer 4 in the plane perpendicular to the first base 1 is an isosceles trapezoid. A base angle θ of the isosceles trapezoid is 57°.

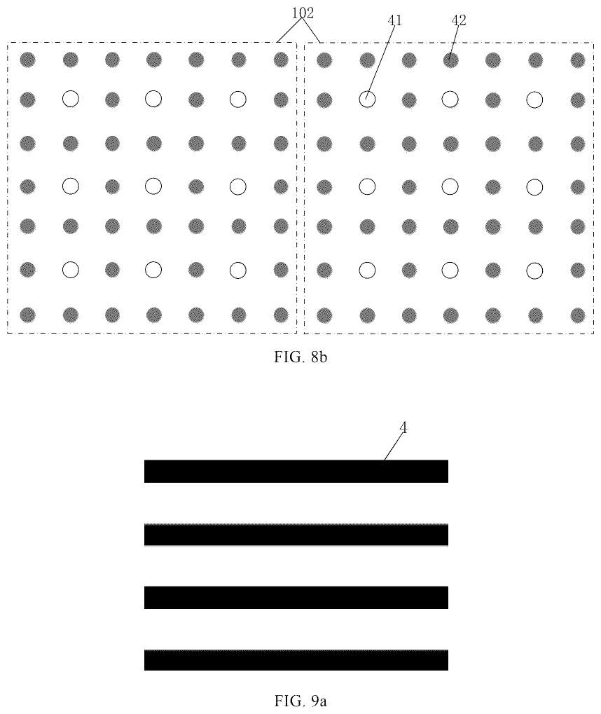

In some embodiments, FIG. 8a is a schematic cross-sectional view of a structure of a first substrate with main spacers and auxiliary spacers according to an embodiment of the present disclosure. FIG. 8b is a schematic view illustrating a distribution of main spacers and auxiliary spacers according to an embodiment of the present disclosure. Referring to FIGS. 8a and 8b, the spacers 4 include main spacers 41 and auxiliary spacers 42, a diameter of a first surface of each main spacer 41 is greater than that of a first surface of each auxiliary spacer 42; and/or a diameter of a second surface of each main spacer 41 is greater than that of a second surface of each auxiliary spacer 42; and/or a height of each main spacer 41 is greater than that of each auxiliary spacer 42.

The main spacers 41 and the auxiliary spacers 42 may well support the first substrate and the second substrate in the flexible dimming module using the first substrate, and on the other hand, can ensure that the spacers can stably support the first substrate and the second substrate when the flexible dimming module is bent and deformed under the action of external force, thereby avoiding the problem of the white spots.

In some embodiments, the diameter of the second surface of each main spacer 41 is 17 μm, the diameter of the first surface of each main spacer 41 is 27 μm, and the height of each main spacer 41 is 12 μm. The diameter of the second surface of each auxiliary spacer 42 is 15 μm, the diameter of the first surface of each auxiliary spacer 42 is 25 μm, and the height of each auxiliary spacer 42 is 11.5 μm.

In some embodiments, the array of spacers 4 includes a plurality of zones 102, the number of spacers 4 within each zone 102 is constant, the number of main spacers 41 is less than the number of auxiliary spacers 42 in each zone 102, and the main spacers 41 are arranged in an array and the auxiliary spacers 42 are arranged in an array in each zone 102.

In some embodiments, referring to FIG. 8b, 49 spacers 4 are distributed within each zone 102, including 9 main spacers 41 and 40 auxiliary spacers 42.

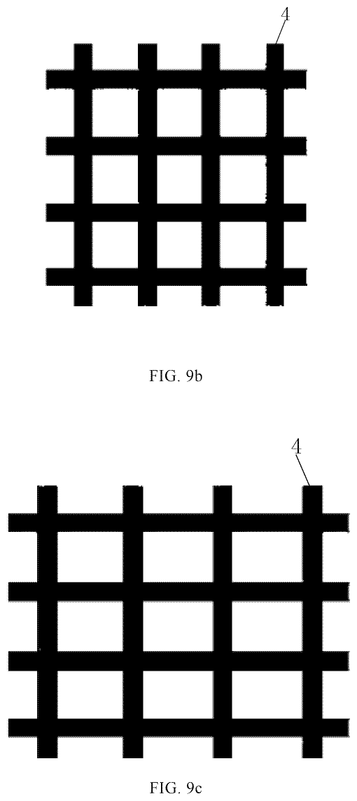

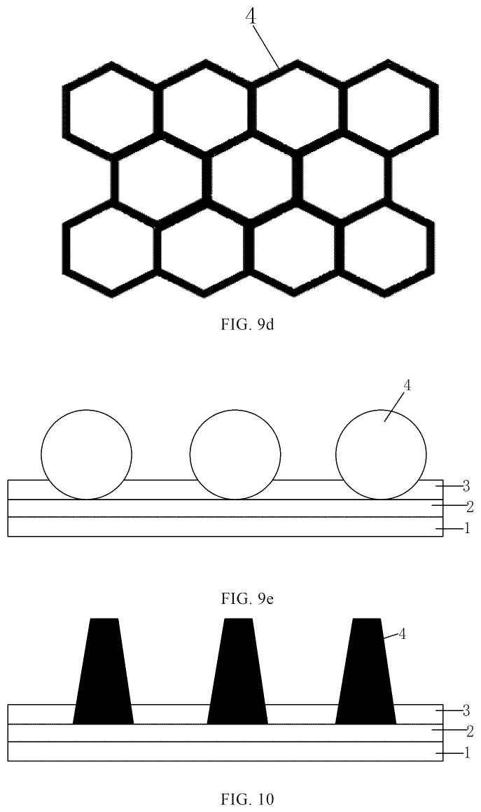

In some embodiments, FIG. 9a is a schematic view illustrating a distribution of strip-shaped spacers according to an embodiment of the present disclosure. Referring to FIG. 9a, the shape of each spacer 4 is strip-shaped, and a length direction of each spacer 4 is along a length direction or a width direction of the first base 1.

In some embodiments, the length of each strip-shaped spacers 4 is equal to the length or the width of the first base 1.

In some embodiments, the spacing distance between any two adjacent strip-shaped spacers 4 is constant and is in a range from 0.05 mm to 1 mm.

In some embodiments, FIG. 9b is a schematic view illustrating a distribution of spacers in a square mesh shape according to an embodiment of the present disclosure. FIG. 9c is a schematic view illustrating a distribution of spacers in a rectangular mesh shape according to an embodiment of the present disclosure. FIG. 9d is a schematic view illustrating a distribution of spacers in a regular hexagonal mesh shape according to an embodiment of the present disclosure. Referring to FIGS. 9b, 9c and 9d, the spacers 4 extend along a first direction and a second direction to form a mesh, and the first direction and the second direction are parallel to the first substrate and intersect with each other. The shape of each spacer 4 is a mesh shape, including a square mesh shape, a rectangular mesh shape or a regular hexagonal mesh shape.

In some embodiments, referring to FIGS. 9a to 9d, a width of the first surface of each spacer 4 in the first conductive layer 2 is in a range from 10 μm to 30 μm, a width of the second surface of each spacer 4 is in a range from 5 μm to 20 μm, and the height of each spacer 4 is in a range from 4 μm to 30 μm.

The widths of the first surface and the second surface of each spacer 4 are widths of orthographic projections of the first surface and the second surface of each spacer 4 on the first base 1, respectively. The height of each spacer 4 is a distance between the second surface and the first surface of each spacer 4.

In the embodiment of the present disclosure, an area of the dimming module supported by the strip-shaped and mesh-shaped spacers 4 is greater than that of the columnar spacers 4, so that a capability of controlling the cell gap by the dimming module is stronger. When the external force is applied to the dimming module, the strip-shaped and mesh-shaped spacers 4 can prevent the liquid crystals in the cell of the dimming module from flowing, and therefore avoid light-shielding or light-transmitting defects caused by the fact that the liquid crystals flow to a local region under the external force, thereby avoiding the local blackening phenomenon of the dimming module.

In some embodiments, FIG. 9e is a schematic view illustrating a distribution of spherical spacers according to an embodiment of the present disclosure. Referring to FIG. 9e, each spacer 4 has a spherical shape. The spherical spacers 4 are in contact with the first conductive layer 2 and the first alignment film 3 and connected to the first conductive layer 2 and the first alignment film 3. Compared with a connection mode that only the point contact between the supporting spacers and the alignment film can be realized in the related art, in the embodiment of the present disclosure, the contact connection area between the spherical spacers 4 and the layers where the spherical spacers are located is greatly increased, so that the connection strength between the spherical spacers 4 and the layers where the spherical spacers are located is improved, the problem that the spherical spacers 4 are easy to fall off is solved or avoided, and the problem of the white spots of the dimming module can be well solved.

In some embodiments. FIG. 10 is a schematic cross-sectional view of a structure of a first substrate with spacers made of a photoresist material containing a black pigment according to an embodiment of the present disclosure. Referring to FIG. 10, the photoresist material further includes a black pigment, a mass percentage of the black pigment in the photoresist material is in a range from 5 wt % to 10 wt %, the black pigment is black particles, and has a particle diameter less than 100 nm.

In some embodiments, the black pigment such as carbon is doped into the photoresist material to form a black acrylic resin which has an optical density (OD, which represents a density of light absorbed by a detection object) of 3 or more, which greatly reduces the transmittance of the spacers 4.

In this embodiment, the photoresist material is light-transmitting without the black pigment, and has the transmittance greater than 90%, so that a transmittance of the dimming module in a dark state is increased, and a contrast of the dimming module is reduced. The photoresist material is doped with the black pigment, which can reduce the transmittance of the spacers 4, reduce the transmittance of the dimming module in the dark state, improve the contrast of the dimming module, and improve the visual experience of the user.

In some embodiments, FIG. 11 is a schematic cross-sectional view of a structure of a first substrate with a black matrix provided at a position of a spacer according to an embodiment of the present disclosure. Referring to FIG. 11, the dimming module further includes a black matrix 5 located between the first conductive layer 2 and each spacer 4, and an orthographic projection of each spacer 4 on the first base 1 is located within an orthographic projection of the corresponding black matrix 5 on the first base 1.

Referring to FIG. 11, the spacers 4 are light-transmitting, and have the transmittance greater than 90%, so that the transmittance of the dimming module in the dark state is increased, and the contrast of the device is reduced. The black matrix 5 is provided between each spacer 4 and the first conductive layer 2, which may absorb the light incident to the spacers 4, and therefore, can reduce the transmittance of the spacers 4, reduce the transmittance of the dimming module in the dark state, improve the contrast of the dimming module, and improve the visual experience of the user.

In some embodiments, a thickness of the black matrix 5 is in a range from about 1 μm to about 3 μm. In order to avoid the light leakage caused by the fact the light is emitted through the spacers 4, each black matrix 5 needs to completely cover the first surface of the corresponding spacer 4, that is, the spacer 4 needs to be completely arranged on the corresponding black matrix 5. Therefore, an area of the orthographic projection of each black matrix 5 on the first base 1 is greater than or equal to that of the first surface of the corresponding spacer 4. The size of the orthographic projection of each black matrix 5 should be a sum of the size of the first surface of the corresponding spacer 4 and an alignment accuracy, which is usually ±3 μm, of the black matrix 5 and the spacer 4.

In some embodiments, the black matrix 5 is made of the photoresist, including a polymer resin, a pigment, a monomer, a photoinitiator, and a solvent and the like. The solvent is generally propylene glycol methyl ether acetate (PGMEA). The polymer resin is generally bisphenol fluorene resin. The monomer is acrylate micromolecule. The photoinitiator belongs to a free radical type, and is generally an oxime ester photoinitiator. The pigment is generally carbon black particles having a particle diameter less than 100 nm.

Based on the above structure of the dimming module, the embodiment of the present disclosure further provides a method for manufacturing the dimming module, including: forming a first substrate. The step of forming the first substrate includes the following steps S1 to S3. The step S1 includes forming a first conductive layer on a first base.

In this step, the first conductive layer is formed by a patterning process, including the steps of film forming, photoresist coating, exposure, development, etching and the like.

The first conductive layer is made of transparent indium tin oxide material, so that the light-transmitting performance of the first substrate can be realized, and the light-transmitting performance of the dimming module can be realized.

The step S2 includes forming a plurality of spacers on the first base after the step S1 is completed.

In some embodiments, the step S2 specifically includes: coating a photoresist film, such as a negative photoresist film, on a side of the first conductive layer away from the first base.

The photoresist film is dried at a temperature in a range from 80° C. to 100° C. for a duration in a range from 100 seconds to 120 seconds, so as to remove the small molecule solvent in the photoresist film and reduce the fluidity of the photoresist.

The photoresist film is exposed by using a mask plate with a light-transmitting pattern through ultraviolet light (that is, UV light, generally in a wave band in a range from 300 nm to 436 nm), so that a part of the photoresist film in a region corresponding to the light-transmitting pattern is subjected to polymerization reaction.

A potassium hydroxide (KOH) solution is sprayed on the exposed photoresist film, and a part of the photoresist film, which is not subjected to the polymerization reaction and is in a region except for the region corresponding to the light-transmitting pattern, is removed, to form a pattern of the spacers. If the potassium hydroxide solution with a mass percentage of 0.04 wt % is sprayed, the portion of the photoresist film which is not subjected to the polymerization reaction is cleaned out.

The pattern of the spacers is cured at a temperature in a range from 100° C. to 110° C. for a duration in a range from 50 minutes to 60 minutes, to form the spacers.

In some embodiments, the columnar spacers, the strip-shaped spacers and the mesh-shaped spacers may be formed by the exposure process, so that the low-temperature process for forming the spacers in the dimming module is realized, and the damage to the flexible performance of the first base caused by the excess temperature for forming the spacers is avoided.

In some embodiments, the step S2 specifically includes: spraying the spherical spacers on a side of the first conductive layer away from the first base.

The spherical spacers are heated at a temperature in a range from 100° C. to 110° C. for a duration in a range from 50 minutes to 60 minutes, to melt a surface layer of each spherical spacer, so that the melted surface layer is converged at an contact interface of the spherical spacer and the first conductive layer.

The spherical spacers are bonded and connected to the first conductive layer by cooling.

In some embodiments, the spherical spacers may be formed by the spraying and curing processes, so that the low-temperature process for forming the spacers in the dimming module is realized, and the damage to the flexible performance of the first base caused by the excess temperature for forming the spacers is avoided.

In some embodiments, the main spacers and the auxiliary spacers may be formed by the above exposure process. Unlike the above method by which the spacers are formed by the exposure process, in such an exposure process for the main spacers and the auxiliary spacers, a halftone mask plate (or a gray scale mask plate) is used to adjust the exposure during exposure. For example, a transmittance of the exposure light at a p of a mask pattern corresponding to a pattern of the main spacers is 100%, and a transmittance of the exposure light at a portion of the mask pattern corresponding to a pattern of the auxiliary spacers is in a range from 30% to 50%, so as to achieve different sizes and heights of the main spacers and the auxiliary spacers.

The step S3 includes forming a first alignment film on the first base after the steps are completed.

In this step, a specific process for forming the first alignment film includes: forming a first alignment film layer on the first base on which the spacers are formed by adopting a coating process or a spraying process.

The first alignment film layer is cured at a temperature in a range from 100° C. to 110° C. for a duration in a range from 80 minutes to 90 minutes.

The first alignment film layer is aligned through a rubbing alignment process or a photo-alignment process to form the first alignment film.

By the method for forming the first alignment film, the low-temperature process for forming the first alignment film in the dimming module is realized, and the damage to the flexible performance of the first base caused by the excess temperature for forming the first alignment film is avoided.

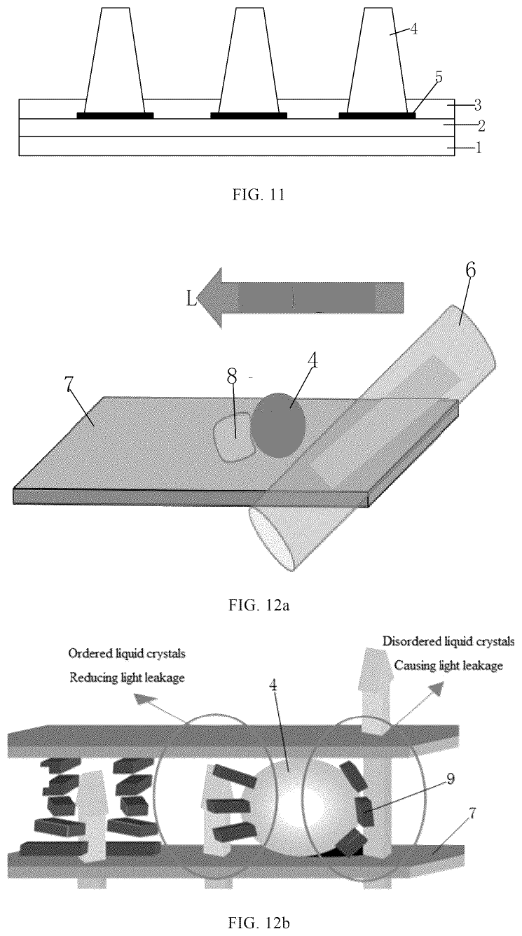

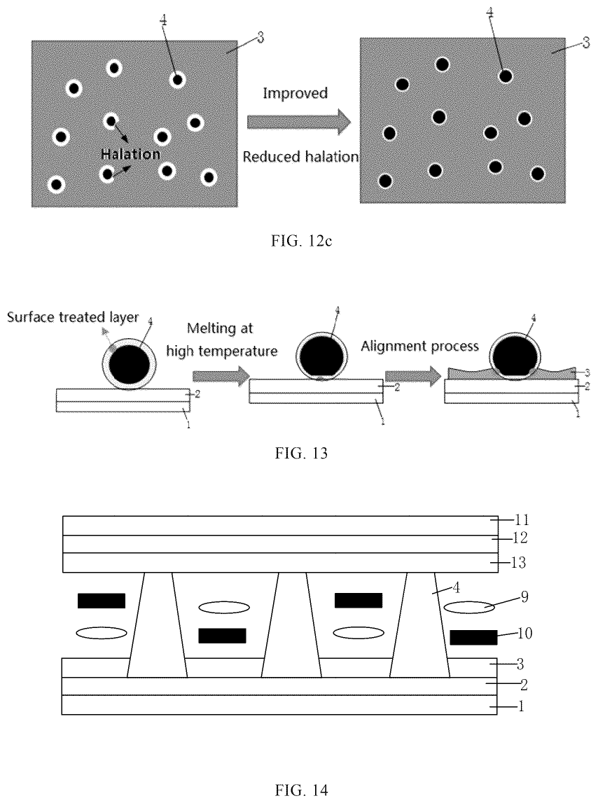

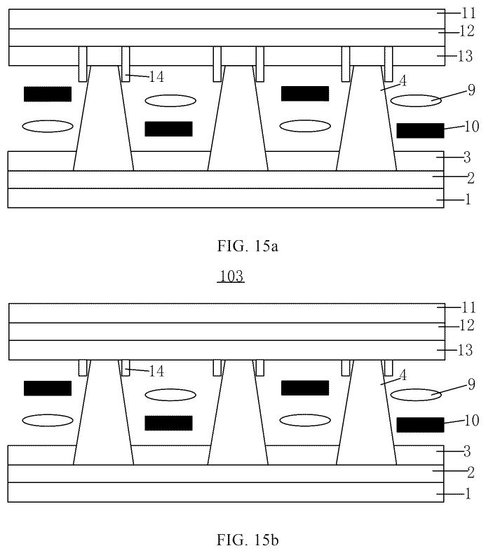

In some embodiments, FIG. 12a is a schematic view illustrating a rubbing shadow region of a first alignment film during a rubbing alignment process. FIG. 12b is a schematic view illustrating a principle of light leakage caused by alignment of liquid crystal molecules around a spacer. Referring to FIG. 12a, in the rubbing alignment process, the rubbing alignment process is performed on a surface of the first alignment film layer 7 by using a rubbing roller 6. In a rubbing direction L, a rubbing shadow region 8 (i.e., a region with reduced rubbing strength) exists due to the blocking of the spacer 4, and the liquid crystal molecules 9 may be abnormally aligned due to the weak alignment in this region, so that the alignment of the liquid crystal molecules 9 around the spacer 4 is disturbed, which causes the light leakage, as shown in FIG. 12b. In some embodiments, there is no rubbing shadow region by adopting the photo-alignment process, so that the light leakage caused by the disordered liquid crystal molecules in the rubbing shadow region can be solved. FIG. 12c is a schematic view illustrating light leakage occurring around spacers in a first alignment film formed through a rubbing alignment process and a photo-alignment process. As can be seen from FIG. 12c, the light leakage around the spacer 4 in the first alignment film 3 aligned by the photo-alignment process is significantly better than the light leakage around the spacer 4 in the first alignment film 3 aligned by the rubbing alignment process.

In some embodiments, the first alignment film layer is formed by coating through a coating process. Due to the spacers arranged at intervals, the region around the spacers may include a portion where the liquid of the first alignment film layer is not coated. The first alignment film layer is formed by adopting a spraying process, so that the problem that there is the portion where the liquid of the first alignment film layer is not coated can be avoided.

In some embodiments, FIG. 13 is a schematic view illustrating a process of sequentially forming spherical spacers and a first alignment film on a first conductive layer. Referring to FIG. 13, the spacer 4 is adhered on the first conductive layer 2 to have an adhering interface between the spacer 4 and the first conductive layer 2, then the first alignment film 3 is formed, and the first alignment film 3 may fill a gap between the spacer 4 and the first conductive layer 2. The thicker the first alignment film 3 is, the more sufficiently the gap is filled, and the greater the adhering interface between the spacer 4 and the first alignment film 3 is. For example, an adhering area between the supporting spacer and the alignment film in the related art is approximately equal to an area of the adhering interface between the spacer 4 and the first conductive layer 2 in the present embodiment. In the present embodiment, the adhering interface further includes a portion between the spacer 4 and the first alignment film 3, so that the adhering area of the spacers 4 are greater, the adhering strength is improved, and the problem that the spacers are easy to fall off in the related art can be effectively solved or avoided.

In some embodiments, the method for manufacturing a dimming module further includes: forming black matrixes after the first conductive layer is formed and before the spacers are formed. The step of forming the black matrixes specifically includes: coating a photoresist film, such as a negative photoresist film for the black matrixes, for forming the black matrixes on a side of the first conductive layer away from the first base.

The photoresist film is dried at a temperature of 90° C. for a duration of 120 seconds, so as to remove the small molecule solvent in the photoresist film and reduce the fluidity of the photoresist.

The photoresist film is exposed by using a mask plate with a light-transmitting pattern through ultraviolet light (that is, UV light, generally in a wave band in a range from 300 nm to 436 nm), so that a portion of the photoresist film in a region corresponding to the light-transmitting pattern is subjected to polymerization reaction.

A potassium hydroxide (KOH) solution is sprayed on the exposed photoresist film, and a portion of the photoresist film, which is not subjected to the polymerization reaction and is in a region except for the region corresponding to the light-transmitting pattern, is removed, to form a pattern of the black matrixes. If the potassium hydroxide solution with a mass percentage of 0.04 wt % is sprayed, the portion of the photoresist film which is not subjected to the polymerization reaction is cleaned out.

The pattern of the black matrixes is cured at a temperature of 110° C. for a duration in a range from 50 minutes to 60 minutes, to form the black matrixes.

In some embodiments, the mask plate used in the process of forming the black matrixes and the mask plate used in the process of forming the spacers may be the same mask plate.

The embodiment of the present disclosure further provides a dimming module. FIG. 14 is a schematic cross-sectional view of a structure of a dimming module according to an embodiment of the present disclosure. Referring to FIG. 14, the dimming module further includes a second substrate and liquid crystals, the second substrate and the first substrate are aligned and assembled to form a cell gap containing the liquid crystals therein, the spacers 4 are positioned in the cell gap to support the second substrate, and the liquid crystals include dye liquid crystals. The dye liquid crystals include liquid crystal molecules 9 and dye molecules 10, and the second substrate includes a second base 11, a second conductive layer 12 and a second alignment film 13 sequentially stacked on the second base 11.

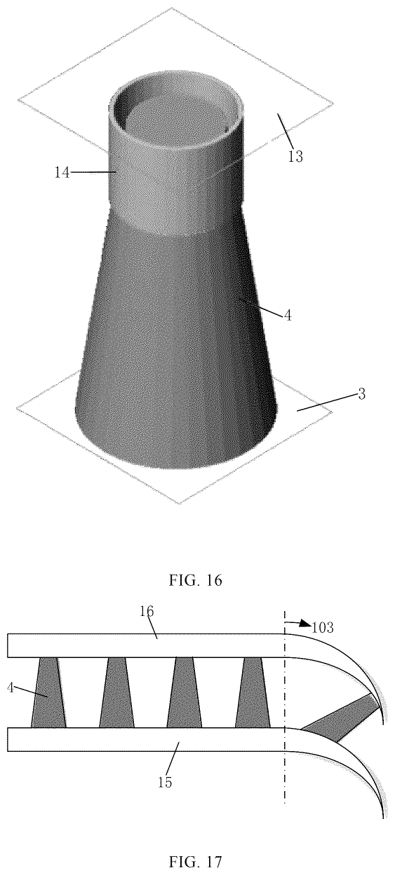

In some embodiments, at least a part of the second surface of each spacer 4 is in contact with the second alignment film 13, and the second base 11 is made of a flexible material. FIG. 15a is a schematic cross-sectional view of a structure of a dimming module in a curved-surface region according to an embodiment of the present disclosure. Referring to FIG. 15a, the dimming module includes a curved-surface region 103, the second substrate further includes at least one retaining ring 14 located in the curved-surface region 103, the at least one retaining ring 14 is located on a side of the second conductive layer 12 close to the dye liquid crystals and extends through the second alignment film 13 to a direction close to the first substrate, and a top portion of each spacer 4 in the curved-surface region 103 is embedded in the corresponding retaining ring 14. Referring to FIG. 16, FIG. 16 is a schematic diagram illustrating that a top portion of a spacer is nested in a retaining ring according to an embodiment of the present disclosure.

In some embodiments, FIG. 15b is a schematic cross-sectional view of another structure of a dimming module in a curved-surface region according to an embodiment of the present disclosure. Referring to FIG. 15b, the at least one retaining ring 14 is located on a side of the second alignment film 13 close to the dye liquid crystals, and extends to the direction close to the first substrate.

FIG. 17 is a schematic cross-sectional view of a structure of a flexible dimming module having a curved-surface region in the related art. Referring to FIG. 17, the curved-surface region 103 of the flexible dimming module is of a hyperbolic arc, a bending degree of the flexible dimming module is greater in a part of the curved-surface region 103 with a larger curvature. The spacers 4 are only adhered to the first substrate 15 and are not adhered to the second substrate 16, so that the first substrate 15 and the second substrate 16 are easily dislocated in the portion of the curved-surface region 103 with a greater bending degree, which causes the cell gap of the curved-surface region 103 of the whole flexible dimming module to change.

In this embodiment, the at least one retaining ring 14 is disposed in the region of the second substrate corresponding to the curved-surface region 103 of the dimming module, and the top portion of each spacer 4 is embedded in the corresponding retaining ring 14 after the second substrate and the first substrate are aligned and assembled, so as to prevent the second substrate and the first substrate from being dislocated from each other, thereby preventing the cell gap of the curved-surface region 103 of the dimming module from being changed.

In some embodiments, the curved-surface region may be an edge curved-surface region formed only at an edge of the dimming module, or may be a whole curved-surface region formed when the whole dimming module is bent.

In some embodiments, the at least one retaining ring 14 is made of the same material as the spacers 4, and a process temperature for forming the at least one retaining ring 14 is lower than the tolerable process temperature of the second base 11. In some embodiments, the at least one retaining ring 14 is made of the same flexible photoresist material as the spacers 4, and the process for forming the at least one retaining ring 14 is the same as that of the spacers 4; that is, the at least one retaining ring 14 is formed by the exposure process, so that the low-temperature process for forming the at least one retaining ring 14 is realized, and the damage to the flexible performance of the second base 11 caused by the excess temperature for forming the at least one retaining ring 14 is avoided.

In some embodiments, the second conductive layer 12 is made of the same material as the first conductive layer 2, the process for forming the second conductive layer 12 is the same as that of the first conductive layer 2, the second alignment film 13 is made of the same material as the first alignment film 3, the process for forming the second alignment film 13 is the same as that of the first alignment film 3, so that the low-temperature process for forming the second alignment film 13 is realized, and the damage to the flexible performance of the second base 11 caused by the excess temperature for forming the second alignment film 13 is avoided.

In some embodiments, the dimming module further includes a border sealing glue (not shown) located in the border region, the second substrate is connected to the first substrate through the border sealing glue by sealing the border, the border sealing glue is added with silicon balls which can support the border sealing glue, and/or the spacers are arranged in a region where the border sealing glue is located, and the spacers can support the border sealing glue.

In some embodiments, a height of each spacer is 12 μm, and a thickness of the cell gap in the dimming module is a difference between the height of the spacer and the thickness of the first alignment film.

In some embodiments, a diameter of each silicon ball is generally between the height of the spacer plus 0.1 μm and the height of the spacer plus 0.5 μm.

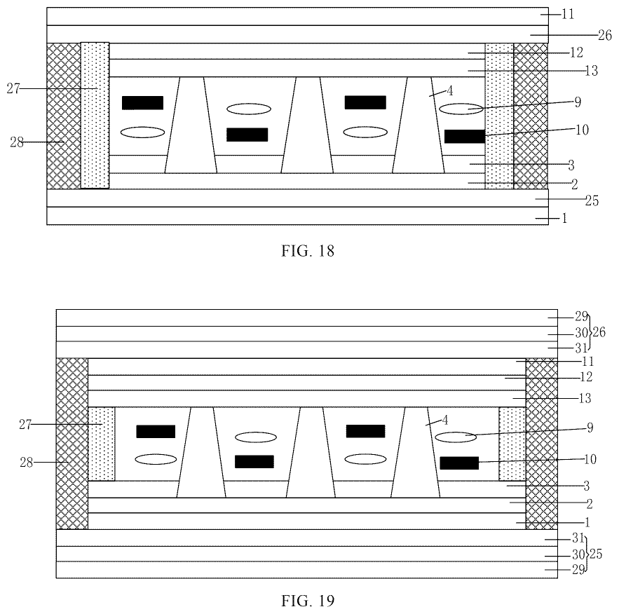

The embodiment of the present disclosure further provides a dimming module. FIG. 18 is a schematic cross-sectional view of another structure of a dimming module according to an embodiment of the present disclosure. FIG. 19 is a schematic cross-sectional view of another structure of a dimming module according to an embodiment of the present disclosure. Referring to FIG. 18 and FIG. 19, the dimming module further includes a first barrier layer 25, a second barrier layer 26 and a side glue, wherein the first barrier layer 25 and the second barrier layer 26 are located between the first substrate and the second substrate, or the first barrier layer 25 is located on a side of the first substrate away from the dye liquid crystals and the second barrier layer 26 is located on a side of the second substrate away from the dye liquid crystals, the side glue is located between the first barrier layer 25 and the second barrier layer 26 and on a side of the border sealing glue 27 away from the dimming region.

In some embodiments, referring to FIG. 18, the first barrier layer 25 is located between the first base 1 and the first conductive layer 2, the second barrier layer 26 is located between the second base 11 and the second conductive layer 12, orthographic projections of the first conductive layer 2, the second conductive layer 12, the first alignment film 3 and the second alignment film 13 on the first base 1 do not overlap with an orthographic projection of the border sealing glue 27 on the first base 1, orthographic projections of the first barrier layer 25 and the second barrier layer 26 on the first base 1 overlap with the orthographic projection of the border sealing glue 27 on the first base 1, and the first barrier layer 25 and the second barrier layer 26 are in contact with the border sealing glue 27 and the side glue 28 and are connected to the border sealing glue 27 and the side glue 28.

By providing the first barrier layer 25 and the second barrier layer 26, the gas barrier performance on the sides of the first substrate and the second substrate can be improved. The border sealing glue 27 is in contact with the first barrier layer 25 and the second barrier layer 26, the border sealing glue 27 is prevented from contacting the first alignment film 3 and the second alignment film 13, and compared with the case that the border sealing glue 27 is in contact with the first alignment film 3 and the second alignment film 13 in the related art, the border sealing glue 27 may form a greater, more stable and more firm adhering force with the first barrier layer 25 and the second barrier layer 26, so that the risk of gas permeation caused by debonding of the border sealing glue 27 with the first alignment film 3 and the second alignment film 13 is avoided.

In some embodiments, a material of the first barrier layer 25 and the second barrier layer 26 includes silicon nitride or silicon oxide.

In some embodiments, a thickness of the first barrier layer 25 is in a range from 1 μm to 2 μm, and a thickness of the second barrier layer 26 is in a range from 1 μm to 2 μm.

In some embodiments, the side glue 28 is located in the border region and on a side of the border sealing glue 27 away from the dimming region, and the side glue 28 is located between the first barrier layer 25 and the second barrier layer 26 and is in contact with the first barrier layer 25 and the second barrier layer 26 and is connected to the first barrier layer 25 and the second barrier layer 26. With the side glue 28, the speed that the external air can enter the dimming module through the border sealing glue 27 is be reduced, and the water vapor separation at the side of the dimming module can be further improved.

In some embodiments, a material of the side glue 28 may be a UV-curable acrylic resin glue, or a thermo-curable epoxy glue or silicone glue. A width of the side glue 28 in a direction away from the border sealing glue 27 may be in a range from 5 mm to 10 mm.

In some embodiments, the first base 1 and the second base 11 may be made of a transparent polymer material such as PET (polyethylene glycol terephthalate), PEN (polyethylene naphthalate), PC (polycarbonate), PPSU (polyphenylsulphone), PES (polyether sulfone), or PMMA (polymethyl methacrylate) or the like, and may have a thickness in a range from 50 μm to 200 μm. The first conductive layer 2 and the second conductive layer 12 may be made of indium tin oxide, gallium nitride, or nano silver or the like, and may have a thickness in a range from 50 nm to 100 nm. The first alignment film 3 and the second alignment film 13 may be made of polyimide, and may have a thickness in a range from 500 angstroms to 1000 angstroms. The spacers 4 may be the spacers 4 in the above embodiments, and a height of each spacer 4 is in a range from 8 μm to 20 μm. The liquid crystal material may be a gray black dye liquid crystal material with a guest-host effect. The border sealing glue 27 is made of a mixture of photo-curable and thermo-curable acrylic resin and epoxy resin, and the width of the border sealing glue 27 in the direction away from the cell gap may be in a range from 1 mm to 5 mm.

The embodiment of the present disclosure further provides a dimming module. Referring to FIG. 19, the first barrier layer 25 is located on a side of the first substrate away from the second substrate, and the second barrier layer 26 is on a side of the second substrate away from the first substrate.

In some embodiments, the side glue 28 is located in the border region and on a side of the border sealing glue 27 away from the dimming region, and the side glue 28 is located between the first barrier layer 25 and the second barrier layer 26 and is in contact with the first barrier layer 25 and the second barrier layer 26 and is connected to the first barrier layer 25 and the second barrier layer 26.

In some embodiments, each of the first barrier layer 25 and the second barrier layer 26 includes a base film 29, a barrier film 30, and an optical adhesive film 31 which are sequentially stacked.

In some embodiments, the base film 29 is made of a transparent polymer and the barrier film 30 is made of silicon nitride or silicon oxide. In some embodiments, the base film 29 may be made of PET, and the optical adhesive film 31 may be made of transparent optical adhesive.

In some embodiments, a thickness of the first barrier layer 25 is in a range from 50 μm to 200 μm, and a thickness of the second barrier layer 26 is in a range from 50 μm to 200 μm. A thickness of the base film 29 is in a range from 25 μm to 175 μm, a thickness of the barrier film 30 is in a range from 1 μm to 2 μm, and a thickness of the optical adhesive film 31 is in a range from 5 μm to 25 μm.

The first barrier layer 25 and the second barrier layer 26 are directly attached to outer sides of the first substrate and the second substrate, respectively in FIG. 19, whereas the first barrier layer 25 and the second barrier layer 26 need to be formed by a chemical vapor deposition process in FIG. 18. Compared with the dimming module shown in FIG. 18, the dimming module shown in FIG. 19 has a simplified process flow for forming the first barrier layer 25 and the second barrier layer 26, and can also achieve a better gas barrier effect, but the dimming module shown in FIG. 19 has more layers and a more complex structure, and challenges the durability of the material of the optical adhesive films 31 and the thermal matching performance between the base films 29 and the first base 1 and the second base 11 in the first barrier layer 25 and the second barrier layer 26. In terms of material selection, the durability of the optical adhesive films 31 against UV ultraviolet rays needs to be focused, and it needs to meet the requirement that the base films 29, the first base 1 and the second base 11 have the equal heat shrinkage performance.

In some embodiments, based on the above structure of the dimming module, the method for manufacturing a dimming module in the embodiments of the present disclosure further includes: forming a second substrate; dripping dye liquid crystals on an opposite surface of a first substrate (a surface of the first substrate close to the second substrate after the first substrate and the second substrate are aligned and assembled), coating a border sealing glue on a peripheral border region of an opposite surface of the second substrate (a surface of the second substrate close to the first substrate after the first substrate and the second substrate are aligned and assembled), and then aligning and assembling the first substrate and the second substrate in vacuum; and cutting redundant parts in the peripheral border region, binding a peripheral circuit board to the peripheral border region, thereby forming the dimming module.

In some embodiments, a laminating pressure test is performed on the first substrate and the second substrate, and the spacers with three distribution densities in the first substrate has a resistance to the laminating pressure more than 80 kgf/cm² in the dimming module in the test.

In some embodiments, forming the first substrate further includes: forming a first barrier layer before the first conductive layer is formed on the first base. Forming the second substrate includes: forming a second barrier layer on the second base, forming a second conductive layer on the second base after the steps are completed, and forming a second alignment film on the second base after the above steps are completed.

Film layers of the first barrier layer and the second barrier layer are formed through chemical vapor deposition, exposure and dry etching processes.

In some embodiments, based on the above structure of the dimming module, the method for manufacturing a dimming module in the embodiments of the present disclosure further includes: forming a second substrate, and aligning and assembling the first substrate and the second substrate. The method further includes: forming the first barrier layer on a side of the first substrate away from the second substrate, and forming a second barrier layer on a side of the second substrate away from the first substrate.

Each of the first barrier layer and the second barrier layer is formed as a stacked film layer formed by sequentially stacking a base film, a barrier film and an optical adhesive film. After the first substrate and the second substrate are aligned and assembled, the first barrier layer and the second barrier layer are respectively applied on the first substrate and the second substrate through the optical adhesive films.

According to the dimming module provided by the embodiment of the present disclosure, on one hand, the spacers 4 are positioned on the first conductive layer 2 and extend away from the first base 1 through the first alignment film 3, so that the spacers 4 are in contact with the first conductive layer 2 and the first alignment film 3 and connected to the first conductive layer 2 and the first alignment film 3. Compared with a connection mode that only the point contact between the supporting spacers and the alignment film can be realized in the related art, in the embodiment of the present disclosure, the contact connection area between the spacers 4 and the layers where the spacers are located is greatly increased, so that the connection strength between the spacers 4 and the layers where the spacers are located is improved, the problem that the spacers 4 are easy to fall off is solved or avoided, and the problem of the white spots of the dimming module can be well solved. On the other hand, the surface of the region around the position of each spacer 4 is covered by the first alignment film 3, which may align the liquid crystal molecules in the dimming module, so that the problem of disordered alignment of the liquid crystal molecules around the spacers 4 can be solved, and the phenomenon of light leakage around the spacers 4 can be improved. On the other hand, the first base 1 is made of a flexible light-transmitting material, and the tolerable process temperature of the first base 1 in the process of manufacturing a dimming module is lower than the tolerable process temperature (such as 230° C. for a glass base) of a traditional hard base (such as a glass base). For example, the tolerable process temperature of the first base 1 which is flexible is generally less than 150° C. A warping dimension of the first base 1 which is flexible in the manufacturing process is required to be less than 0.5 mm. The process temperature for forming the spacers 4 is less than the tolerable process temperature of the first base 1, which can ensure that the forming of the spacers 4 cannot change the flexible performance parameter of the first base 1, so that the flexible performance of the dimming module formed with the spacers 4 in this embodiment is more stable, and the flexible performance requirement on the dimming module can be met.

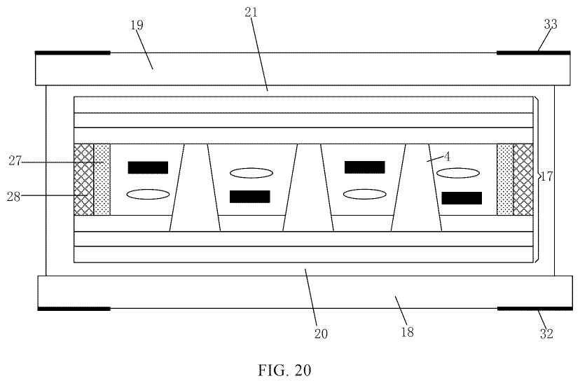

The embodiment of the present disclosure further provides a dimming apparatus. FIG. 20 is a schematic cross-sectional view of a structure of a dimming apparatus according to an embodiment of the present disclosure. Referring to FIG. 20, the dimming apparatus includes the dimming module 17 in the above embodiments, and further includes a first cover plate 18 and a second cover plate 19, and the dimming module 17 is positioned between the first cover plate 18 and the second cover plate 19, the first substrate in the dimming module 17 is attached and adhered to the first cover plate 18 through a first adhesive layer 20, the second substrate in the dimming module 17 is attached and adhered to the second cover plate 19 through a second adhesive layer 21, and the first cover plate 18 and the second cover plate 19 are adhered to each other by sealing the border through the first adhesive layer 20 and the second adhesive layer 21.

In some embodiments, the dimming apparatus is formed by aligning and assembling the first cover plate 18, the dimming module 17 and the second cover plate 19, melting the first adhesive layer 20 and the second adhesive layer 21 through heating, and applying a pressure to laminate these components together. The laminating pressure of the dimming apparatus is generally 12 bar≈12 kgf/cm², and therefore, it can be seen that the spacers with three distribution densities in the dimming module of the above embodiments has a resistance to the laminating pressure of the dimming apparatus.

In some embodiments, the dimming apparatus further includes a first edge covering layer 32 and a second edge covering layer 33, the first edge covering layer 32 is located on a side of the first cover plate 18 away from the second cover plate 19, and an orthographic projection of the first edge covering layer 32 on the first cover plate 18 covers a region from the border sealing glue 27 in the dimming module 17 to an edge of the first cover plate 18, the second edge covering layer 33 is located on a side of the second cover plate 19 away from the first cover plate 18, and an orthographic projection of the second edge covering layer 33 on the second cover plate 19 covers a region from the border sealing glue 27 in the dimming module 17 to an edge of the second cover plate 19. That is, the orthographic projections of the first edge covering layer 32 and the second edge covering layer 33 on the first cover plate 18 cover regions of the border sealing glue 27, the side glue 28 and the edges of the first cover plate 18 and the second cover plate 19 on a side of the side glue 28 away from the border sealing glue 27.

In some embodiments, the first edge covering layer 32 is formed by printing ink on the peripheral region of the first cover plate 18, and the second edge covering layer 33 is formed by printing ink on the peripheral region of the second cover plate 19.

The dimming apparatus provided in the embodiment of the present disclosure can solve the problem of the white spots of the dimming apparatus and improve the quality of the dimming apparatus by using the dimming module in the embodiments.

The dimming apparatus in the embodiment of the present disclosure may be used as various dimming windows, such as vehicle windows or indoor windows or the like.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A dimming module, comprising: a first substrate, a second substrate, a plurality of spacers, a border sealing glue and dye liquid crystals;
wherein the first substrate comprises a first base, a first conductive layer and a first alignment film;
the first conductive layer and the first alignment film are sequentially stacked on a side of the first base close to the dye liquid crystals;
the plurality of spacers are on a side of the first conductive layer close to the dye liquid crystals;
the second substrate comprises a second base, a second conductive layer and a second alignment film;
the second conductive layer and the second alignment film are sequentially stacked on a side of the second base close to the dye liquid crystals;
the second substrate and the first substrate are aligned with each other and assembled together, the border sealing glue is between the first substrate and the second substrate and surrounds to form a dimming region, and the dye liquid crystals are in the dimming region; and
in the dimming region, a spacing distance between any two adjacent spacers is in a range from 50 μm to 1000 μm.

2. (canceled)

3. The dimming module according to claim 1, wherein an orthographic projection of the plurality of spacers on the first substrate overlaps with an orthographic projection of the border sealing glue on the first substrate.

4. The dimming module according to claim 3, wherein a minimum distance between the plurality of spacers and a first edge of the border sealing glue away from the dimming region is less than the spacing distance between any two adjacent spacers.

5. The dimming module according to claim 3, wherein a minimum distance between the plurality of spacers and the first edge of the border sealing glue away from the dimming region is greater than the spacing distance between any two adjacent spacers.

6. The dimming module according to claim 1, wherein the spacing distance between any two adjacent spacers is in a range from 50 μm to 500 μm; and
wherein a radial size of a first surface of each spacer on the first conductive layer is in a range from 10 μm to 40 μm,
a radial size of a second surface of each spacer is in a range from 5 μm to 30 μm, and
a height of each spacer is in a range from 4 μm to 30 μm.

7. (canceled)

8. The dimming module according to claim 76, wherein the radial size of the first surface of each spacer is in a range from 20 μm to 30 μm, the radial size of the second surface of each spacer is in a range from 10 μm to 20 μm, and the height of each spacer is in a range from 8 μm to 15 μm.

9. The dimming module according to claim 1, wherein the plurality of spacers comprise main spacers and auxiliary spacers;
a radial size of a first surface of each main spacer is greater than that of a first surface of each auxiliary spacer; and/or
a radial size of a second surface of each main spacer is greater than that of a second surface of each auxiliary spacer; and/or
a height of each main spacer is greater than that of each auxiliary spacer.

10. The dimming module according to claim 1, wherein the spacing distance between any two adjacent spacers is in a range from 0.05 mm to 1 mm, and
the plurality of spacers extend along a first direction and a second direction to form a mesh, and the first direction and the second direction are parallel to the first substrate and intersect with each other.

11. The dimming module according to claim 10, wherein a width of the first surface of each spacer on the first conductive layer is in a range from 10 μm to 30 μm,
a width of the second surface of each spacer is in a range from 5 μm to 20 μm,
the height of each spacer is in a range from 4 μm to 30 μm; and
the plurality of spacers have a mesh shape, which comprises a square mesh shape, a rectangular mesh shape or a regular hexagonal mesh shape.

12. The dimming module according to claim 1, further comprising a black matrix between the first conductive layer and the plurality of spacers, wherein an orthographic projection of the plurality of spacers on the first base is within an orthographic projection of the black matrix on the first base.

13. The dimming module according to claim 21, wherein the second surface of each of at least a part of the plurality of spacers is in contact with the second alignment film;
the dimming module comprises a curved-surface region,
the second substrate further comprises at least one retaining ring in the curved-surface region,
the at least one retaining ring is on a side of the second conductive layer close to the dye liquid crystals, and passes through the second alignment film and extends towards the first substrate; or the at least one retaining ring is on a side of the second alignment film close to the dye liquid crystals and extends towards the first substrate; and
a top portion of each spacer in the curved-surface region is embedded in a corresponding retaining ring of the at least one retaining ring.

14. The dimming module according to claim 1, further comprising a first barrier layer, a second barrier layer and a side glue,
wherein the first barrier layer and the second barrier layer are between the first substrate and the second substrate, or the first barrier layer is on a side of the first substrate away from the dye liquid crystals and the second barrier layer is on a side of the second substrate away from the dye liquid crystals, and
the side glue is between the first barrier layer and the second barrier layer and arranged on a side of the border sealing glue away from the dimming region.

15. The dimming module according to claim 14, wherein the first barrier layer is between the first base and the first conductive layer;
the second barrier layer is between the second base and the second conductive layer;
orthographic projections of the first conductive layer, the second conductive layer, the first alignment film and the second alignment film on the first base do not overlap with orthographic projections of the border sealing glue and the side glue on the first base, and
orthographic projections of the first barrier layer and the second barrier layer on the first base overlap with the orthographic projections of the border sealing glue and the side glue on the first base, and the first barrier layer and the second barrier layer are in contact with the border sealing glue and the side glue and are connected to the border sealing glue and the side glue.

16. The dimming module according to claim 14, wherein the first barrier layer is on a side of the first substrate away from the second substrate;
the second barrier layer is on a side of the second substrate away from the first substrate;
an orthographic projection of the side glue on the first barrier layer does not overlap with the first substrate;
an orthographic projection of the side glue on the second barrier layer does not overlap with the second substrate; and
the side glue is in contact with the first barrier layer and the second barrier layer and is connected to the first barrier layer and the second barrier layer.

17. The dimming module according to claim 15, wherein the first barrier layer and the second barrier layer have a material of silicon nitride or silicon oxide; and
a thickness of the first barrier layer is in a range from 1 μm to 2 μm; and
a thickness of the second barrier layer is in a range from 1 μm to 2 μm.

18. (canceled)

19. The dimming module according to claim 16, wherein each of the first barrier layer and the second barrier layer comprises a base film, a barrier film and an optical adhesive film which are sequentially stacked together; and
a thickness of the first barrier layer is in a range from 50 μm to 200 μm; and
a thickness of the second barrier layer is in a range from 50 μm to 200 μm.

20. (canceled)

21. The dimming module according to claim 1, wherein an elastic recovery rate of the plurality of spacers under a pressure in a range from 5 mN to 30 mN is in a range from 80% to 90%; and
the dimming module has a resistance to a laminating pressure more than 80 kgf/cm².

22. (canceled)

23. A dimming apparatus, comprising the dimming module according to claim 1;
wherein the dimming apparatus further comprises a first cover plate and a second cover plate, and the dimming module is between the first cover plate and the second cover plate,
the first substrate in the dimming module is attached and adhered to the first cover plate through a first adhesive layer,
the second substrate in the dimming module is attached and adhered to the second cover plate through a second adhesive layer, and
the first cover plate and the second cover plate are adhered to each other by the first adhesive layer and the second adhesive layer for sealing.

24. The dimming apparatus according to claim 23, further comprising a first edge covering layer and a second edge covering layer,
wherein the first edge covering layer is on a side of the first cover plate away from the second cover plate, and an orthographic projection of the first edge covering layer on the first cover plate covers a region from the border sealing glue in the dimming module to an edge of the first cover plate, and
the second edge covering layer is on a side of the second cover plate away from the first cover plate, and an orthographic projection of the second edge covering layer on the second cover plate covers a region from the border sealing glue in the dimming module to an edge of the second cover plate.

25-26. (canceled)
